(19) United States
(12) Patent Application Publication
(10) Pub. No.: US 2020/0380574 A1
(43) Pub. Date: Dec. 3, 2020

(54) Automobile Purchase Method

(71) Applicant: Paul Kennedy, Nepean (CA)

(72) Inventor: Paul Kennedy, Nepean (CA)

(21) Appl. No.: 16/882,505

(22) Filed: May 24, 2020

Related U.S. Application Data
(60) Provisional application No. 62/853,646, filed on May 28, 2019.

(51) Int. Cl. G06Q 30/06; G06Q 20/08; G06Q 20/12; G06Q 40/02; G06Q 30/02

(52) U.S. Cl. CPC G06Q 30/0603; G06Q 30/0643; G06Q 30/0637; G06Q 20/085; G06Q 20/127; G06Q 40/08; G06Q 30/0627; G06Q 30/0208; G06Q 30/0278; G06Q 30/0621; G06Q 40/025

(57) ABSTRACT

A method of facilitating the purchase of a vehicle wherein the present invention includes a software application operable to guide a potential buyer through ever step required to conduct a vehicle purchase and subsequently have parameters of a potential vehicle purchase submitted to enrolled dealers. The present includes utilization of real-time data from enrolled dealers and/or manufacturers of vehicles available for sale which is populated into the database of the present invention. The operator of the present invention maintains the database and graphical software interface. A buyer will navigate through the provided data entry fields and information to arrive at completion of desired terms for the potential purchase of a vehicle. The operator of the present invention will submit the terms to at least one dealer for review. The enrolled dealers and the operator of the present invention have a relationship therebetween that includes an agreed upon fee structure.

### PRIORITY UNDER 35 U.S.C SECTION 119(E) & 37 C.F.R. SECTION 1.78

This nonprovisional application claims priority based upon the following prior United States Provisional patent Application entitled: Automobile Purchase Software Application, Application No.: 62/853,646 filed May 28, 2019, in the name of Paul Kennedy, which is hereby incorporated by reference for all purposes.

### FIELD OF INVENTION

The present invention relates generally to the process of purchasing an automobile, more specifically but not by way of limitation, a software application that provides a complete interactive dashboard offering accurate and current data parameters for the prospective purchaser of a vehicle and further provide highly qualified leads to enrolled automobile dealers.

### BACKGROUND

As is known in the art, the purchasing of a vehicle is major decision in an individual's life. The cost of a new vehicle can easily approach one third of an individual's annual income and as such is a decision that must be executed with deliberate diligence. Conventional vehicle buying methods over the last decade previously involved going to automobile dealers to view the inventory and collect data so as to make a decision about the type of vehicle purchase. Over the last decade, the level of information available to a potential buyer has become easily accessible and this information can be assimilated prior to visiting an automobile dealer. Parameters that are routinely evaluated include but are not limited to vehicle attributes, purchase price, cost of financing and trade-in value of a vehicle currently owned by the prospective buyer.

One problem currently experienced by potential buyers is the lack of consolidation of all of the parameters that must be researched when evaluating the purchase of a vehicle. By way of example but not limitation, there are website that an individual can utilize to determine the approximate trade-in value of their currently owned vehicle. While these sites provide relevant and useful data concerning this data parameter they are void of the capability to assist with other parameters such as but not limited to incorporating lien amounts or providing tax information. Additionally, there are financially focused websites that can be utilized by a prospective buyer to calculate potential payments but while these sites provide some relevant financial data they are void of the aforementioned providers. Lastly, automobile dealers do not have access to the prospective buyer information that are utilizing the aforementioned type of website during the process of vehicle purchase evaluation.

It is intended within the scope of the present invention to provide an interactive software platform providing a graphical dashboard that assimilates all data parameters involved in purchasing a vehicle so as to assimilate for a potential buyer and further provide the potential buyer information to an automobile dealer.

### SUMMARY OF THE INVENTION

It is the object of the present invention to provide an interactive software platform that incorporates all data pertinent to the evaluation of purchasing a vehicle in a graphical dashboard that further provides user manipulation of each data category.

Another object of the present invention is to provide a software based interactive dashboard the incorporates and leverages data input from a user wherein the dashboard facilitates the ability for a user to evaluate a multitude of parameters required for a vehicle purchase.

A further object of the present invention is to provide an interactive software platform that incorporates all data pertinent to the evaluation of purchasing a vehicle in a graphical dashboard that is manufacturer agnostic and provides real time vehicle specification and promotion data from all enrolled vehicle manufacturers.

Still another object of the present invention is to provide a software based interactive dashboard the incorporates and leverages data input from a user wherein the present invention further includes the providing of vehicle evaluation for a currently owned vehicle by the user of the present invention.

An additional object of the present invention is to provide an interactive software platform that incorporates all data pertinent to the evaluation of purchasing a vehicle in a graphical dashboard wherein the present invention will facilitate the establishment of a relationship between a user and an enrolled automobile dealer.

Yet a further object of the present invention is to provide a software based interactive dashboard the incorporates and leverages data input from a user that further provides the ability for a user to determine a payment for a selected vehicle and further evaluate numerous financing alternatives.

Another object of the present invention is to provide an interactive software platform that incorporates all data pertinent to the evaluation of purchasing a vehicle in a graphical dashboard that further includes the ability to facilitate the evaluation of various vehicle packages and insurance cost for the specified vehicle.

An alternate object of the present invention is to provide a software based interactive dashboard the incorporates and leverages data input from a user wherein the present invention further includes the incorporation of a credit application to be completed and potentially shared with an automobile dealer.

Still a further object of the present invention is to provide an interactive software platform that incorporates all data pertinent to the evaluation of purchasing a vehicle in a graphical dashboard that further includes incorporation of any manufacturer promotions available to a potential buyer for a selected vehicle.

An additional object of the present invention is to provide a software based interactive dashboard the incorporates and leverages data input from a user wherein the present invention will provide the vehicle deal opportunity information and potential buyer information to an enrolled automobile dealer.

A further object of the present invention is to provide an interactive software platform that incorporates all data pertinent to the evaluation of purchasing a vehicle in a graphical dashboard wherein the present invention provides alteration of relevant data fields subsequent entry of data that has an impact on the parameters of the data fields being changed.

An alternative objective of the present invention is to provide a software based interactive dashboard the incorporates and leverages data input from a user wherein the present invention provides all relevant terms related to parameters such as but not limited to settlement rate.

Yet a further object of the present invention is to provide an interactive software platform that incorporates all data pertinent to the evaluation of purchasing a vehicle in a graphical dashboard wherein the interactive dashboard of the present invention automated calculation of trade-in allowances.

An additional object of the present invention is to provide a software based interactive dashboard the incorporates and leverages data input from a user wherein the interactive user further facilitates the entry of vehicle accessory packages such as but not limited to rust proofing and theft recovery features.

A further object of the present invention is to provide an interactive software platform that incorporates all data pertinent to the evaluation of purchasing a vehicle in a graphical dashboard wherein the present invention provides the ability to input the vehicle identification number of the currently owned vehicle of the potential buyer and provide input of the data parameters thereof into the relevant field of the interactive dashboard.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a schematic diagram of the operational components of the present invention; and

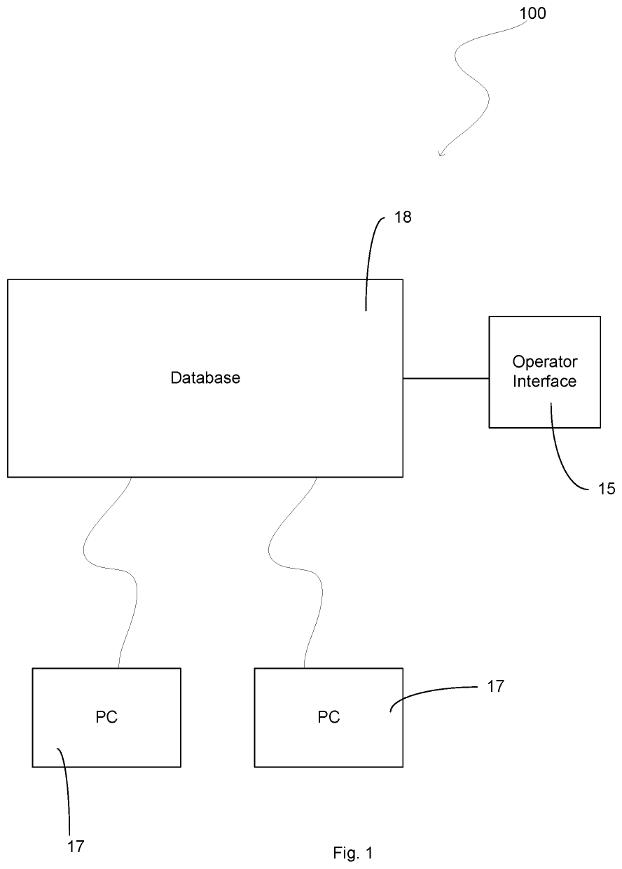

FIG. 2 is an exemplary process flow facilitated by the present invention for a vehicle purchase; and

FIG. 2a is a continuation of the process flow of FIG. 2; and

FIG. 3 is a process flow facilitated by the present invention for a vehicle valuation.

### DETAILED DESCRIPTION

References now to the drawings submitted herewith, wherein various elements depicted therein are not necessarily drawn to scale and wherein through the views and figures like elements are referenced with identical reference numerals, there is illustrated an automobile procurement method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the drawings submitted herewith, automobile procurement method 100 is facilitated utilizing a software database 10 that is operably coupled to the Internet via suitable communication protocols. The software of the present invention provides a graphical user interface in order to facilitate the process of the purchase of a vehicle as is further discussed herein. The software database 10 is communicably coupled to an operator interface 15 wherein the operator interface 15 provides the ability for the operator of the automobile procurement method 100 to execute the required maintenance and updates of the software database 10. The software database 10 is accessible to users via computing devices 17. It should be understood within the scope of the present invention that the automobile procurement method 100 could be provided as a software application on a device such as but not limited to a smart phone or be provided as a website having the necessary graphical interface to execute the process discussed herein. The operator of the automobile procurement method 100 executes tasks such as but not limited to software maintenance and updates and enrollment of vehicle dealers wherein the latter is further discussed herein.

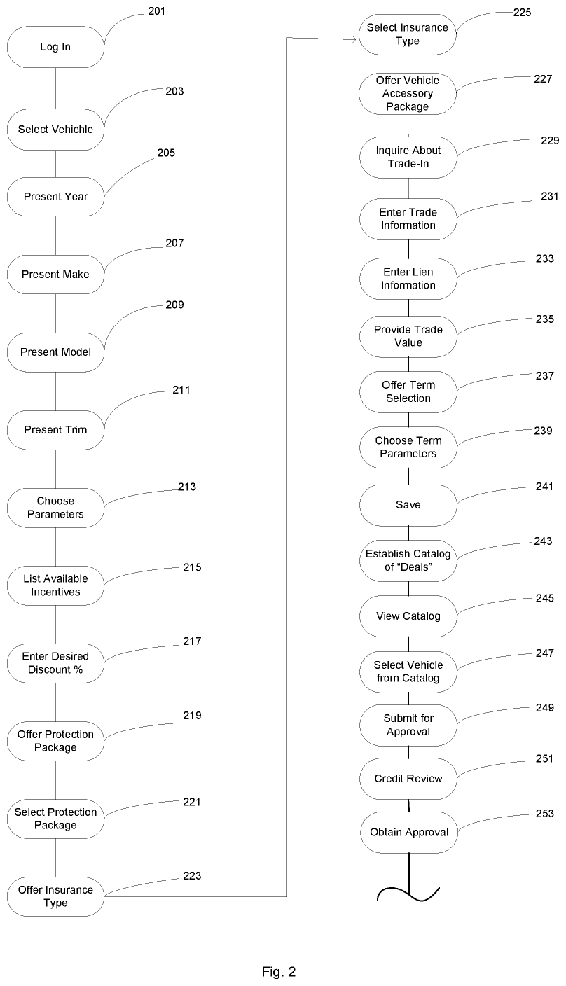

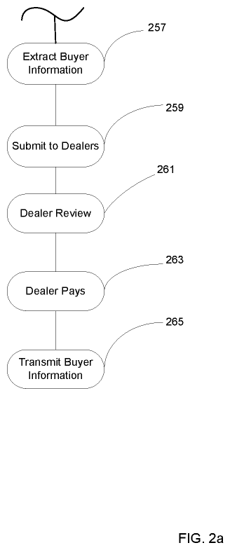

Now referring to FIG. 2 submitted as a part hereof, an exemplary vehicle purchase process flow of the automobile procurement method 100 is outlined therein. In step 201, a user will access the software application of the automobile procurement method 100 either via a software application installed on a smart phone or via an alternate computing device and utilizing the graphical interface thereof. In step 203, the user is presented with vehicle category options of either new or pre-owned and selection is input by the user. Step 205 through Step 211 the user is presented with vehicle parameters that will begin the categorization of the type of vehicle that is desired to be evaluated for purchase by the user. The vehicle parameters include year, manufacturer, model and trim package. The aforementioned vehicle parameters are provided in a preferred embodiment of a drop down style menu wherein some of the parameters such as but not limited to model and trim are derived and presented as a result of the alternate parameters selected. It should be understood within the scope of the present invention that the vehicle parameters identified in steps 205 through 211 are exemplary and it is contemplated within the scope of the present invention that additional parameters could be provided for the user to select therefrom.

In step 213, the user will have completed the selection of the aforementioned vehicle parameters. Step 215, ensuing selection of the vehicle parameters the user will be presented a selection of available financial incentives that are offered by either from the manufacturer selected or from a dealer that is an enrolled participant in the automobile procurement method 100. The incentives can include but are not limited to cash back offers, financing rates, loyalty program offers and military program offers. Step 217, the user is prompted to enter a desired discount wherein the desired discount is the preferred amount in anticipated reduction of the vehicle price from a dealer upon presentation of the vehicle selection thereto. In step 219, the user is provided with various protection packages to choose from and decide as to whether or not to be included as part of the vehicle purchase. These protection packages can include but are not limited to paint protection, rustproofing and fabric protection. Step 221, if desired a user will select at least one of the offered vehicle protection packages.

In step 223, the user will be offered insurance options. It is contemplated within the scope of the present invention that the user can be offered options such as but not limited to warranty extension options and replacement value insurance options. It is further contemplated within the scope of the present invention that during step 223, insurance providers will be contacted and offered the opportunity to pay for a lead to offer insurance plans to the buyer. Step 225, if desired a user will select from the provided insurance options and include the desired options. Subsequently, in step 227, the user will be provided with a plurality of vehicle accessory packages. As with the options discussed herein, each vehicle accessory package is listed and a fully itemized content list thereof is provided either in a drop down graphical menu or other suitable viewing format. It is contemplated within the scope of the present invention that the vehicle accessory packages provided are packages such as but not limited to roof racks, tire and wheel packages and entertainment system options. It is further contemplated within the scope of 227, that the vehicle accessory package information is sent real time to providers of the selected vehicle accessory package wherein each provider can opt to purchase the information of the buyer and contact in order to provide the selected vehicle accessory package.

Step 229, the software application will provide an inquiry prompt to the user so as to determine whether or not the user has a vehicle that is to be traded into the dealer as part of the overall vehicle purchase transaction. If there is no trade-in vehicle then the user will be advanced to step 237 listed herein for continuation of the vehicle purchase facilitated by the software of the automobile procurement method 100. If a trade-in vehicle is identified in step 229, the user will be prompted to enter information about the trade-in vehicle in step 231. Step 231 will consistent of input fields wherein the user will enter vehicle parameters such as but not limited to year, manufacturer, model, trim and mileage. Furthermore, it is contemplated within the scope of the present invention that the user may further be presented the option to upload photographs of the vehicle to be stored with the inputted information that will be transferred to an enrolled dealer as further discussed herein. Additionally, during evaluation of the trade-in, it is contemplated within the scope of the present invention that the software of the present invention could facilitate the real-time transfer of the trade-in information to at least one auction house or used vehicle buyer wherein a tender offer can be issued to the user for use during the buying process. In step 233, the user will be prompted to enter any lien information on the trade-in vehicle. Step 235, ensuing collection of all of the aforementioned parameters concerning the trade-in vehicle, the user is presented with a net value of the trade-in wherein the net value can be incorporated into the vehicle purchase transaction. It should be further understood within the scope of the present invention that the trade-in vehicle could have a lien value greater than the trade-in value and as such the user would be notified in step 235.

In step 237, the user is presented with a plurality of input fields to initiate selection of the desired financial terms of the vehicle purchase being facilitated by the automobile procurement method 100. Step 239, the user will enter and/or select the desired financial terms presented in step 237. By way of example but not limitation, the financial terms can include but are not limited to, total dollar amount, quantity of payments, down payment, first payment date, credit score and desired payment frequency. Subsequent to entering the financial terms the user is presented with an icon that provides the ability to save all of the information entered and/or selected through step 239. A record data file is created and saved to the database 10 wherein the record data file is associated with the creating user. In step 243, the software of the automobile procurement method 100 establishes a catalog of potential purchases. The catalog is specific to each user and includes the saved entered parameters of each potential vehicle purchase. It should be understood within the scope of the present invention that a user can enter a plurality of potential vehicle purchases as part of the automobile procurement method 100 for subsequent viewing and transmission of one or more to an enrolled dealer that participates in the automobile procurement method 100.

In step 245, if a user has established a catalog containing at least one potential vehicle purchase transaction parameter collection, the user can review one or all of the entries in the catalog. In step 247, the user will select either one or more than one potential vehicle transaction from the catalog and initiate submission for approval. If desired the user can select more than one potential vehicle purchase transaction and execute comparisons thereof. It should be understood within the scope of the present invention that the user could not use the catalog feature and enter parameters for a single potential vehicle purchase and submit for approval without storing for subsequent retrieval. Step 249, the user will submit the potential vehicle purchase for approval. In step 251, as part of the approval process, the operator of the automobile procurement method 100 will collect various articles of data from the user to analyze for buyer qualification in order to pre-qualify the buyer prior to submitting the potential vehicle purchase to an enrolled dealer. Step 251 includes the collection and analysis of data such as but not limited to home ownership, years at residence, employment information and income. In step 253, the operator of the automobile procurement method 100 will analyze the inputted data from step 251 and determine whether or not the buyer is qualified to continue with the potential vehicle purchase and if the criteria is met the approval is obtained.

In step 257, the operator of the automobile procurement method 100 will extract the buyer information from the catalog record of the buyer/user wherein the information extracted includes data that can provide information such as but not limited to name and contact information. Step 259, the operator of the automobile procurement method 100 will submit the potential vehicle purchase transaction information to at least one enrolled dealer for review thereof. It should be understood within the scope of the present invention that the potential vehicle purchase transaction data can be submitted to more than one dealer concurrently by the operator. It is further contemplated within the scope of the present invention that the potential vehicle purchase transaction could be transmitted based on parameters such as but not limited to manufacturer specific, vehicle type and dealer prioritization. In step 261, the enrolled dealer receives the potential vehicle transaction data and reviews the information for the buyers desired vehicle and terms. Step 263, the enrolled dealer will provide a fee to the operator of the automobile procurement method 100 for the contact information of the potential buyer if the dealer wishes to pursue completion of the potential vehicle purchase. It is contemplated within the scope of the present invention that the enrolled dealers could participate in the automobile procurement method 100 utilizing alternate types of compensation structures. By way of example but not limitation, the enrolled dealers could provide a bid amount to receive the lead/potential vehicle purchase information. Alternatively, the enrolled dealers could pay a subscription to receive leads or a certain quantity thereof over a defined term. Lastly, the enrolled dealers could be members of a tiered subscription program wherein the enrolled dealers can pay the operator different fees in order to establish a priority structure of receiving leads amongst enrolled dealers. In step 265, the operator of the automobile procurement method 100 transmits the contact information to the enrolled dealer.

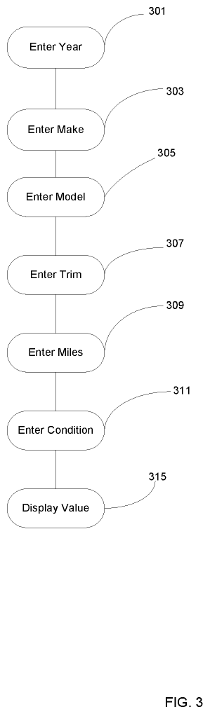

Now referring in particular to FIG. 3, an exemplary utilization of the software of the automobile procurement method 100 for use of analysis of a potential trade-in vehicle is diagrammed therein. It should be understood within the scope of the present invention that the software of the present invention can be utilized by a user as a tool for evaluation of a vehicle owned by the user either as part of a complete potential vehicle transaction as described herein above or as a standalone feature. The ensuing parameters can be inputted either through data entry fields or be driven by pre-populated drill down style menus. In step 301, the user will enter the year of the vehicle owned by the user. In step 303, the user will enter the manufacturer data of the vehicle. Step 305, the user will input the model of the vehicle. In step 307, the user will enter the trim package information of the selected model of the vehicle. Step 309, the user will input the mileage of the vehicle. In Step 311, the user will input the condition of the vehicle. During this step the operator may provide the option to include up to four photos of the vehicle if desired to be submitted by a user as part of a potential vehicle purchase. In step 315, the software of the present invention will provide a graphic display of the value of the vehicle owned by the user. The value can be a finite number or can be provided as a range wherein the range is dependent upon condition and other market influencers. It is further contemplated within the scope of the present invention that other processes of the present invention as described herein could be implemented as a standalone transaction or as part of the entire process defined herein. It should be further understood within the scope of the present invention, that various data information pertaining to available vehicles for potential sale could be populated into the database 10 in real-time for use by a potential buyer.

It is further contemplated within the scope of the present invention that the software interface of the automobile procurement method 100 could be modified to be specific to a certain dealer or dealer network focused on one or a plurality of manufacturers. In the aforementioned alternate embodiment the process flow described herein would apply wherein the process flow would be targeted to a specific dealer or manufacturer of certain vehicles or types thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A method operable to facilitate a purchase of a vehicle wherein the method comprises the steps of:
providing a database, wherein the database further includes a software with the software providing a graphical interface for a user to engage in the method;
accessing the software, wherein a potential buyer accesses the software via a suitable computing device;
capturing data pertaining to the potential buyer;
initiating a potential vehicle purchase transaction, wherein the potential vehicle purchase transaction includes data entry of a plurality of parameters on a desired vehicle;
entering desired financial terms, wherein the potential buyer provides the desired financial terms of the potential vehicle transaction;
submitting the potential vehicle purchase transaction for approval;
reviewing the potential vehicle purchase transaction;
approving the potential vehicle purchase transaction;
extracting the captured data of the potential buyer;
submitting data regarding the potential vehicle purchase transaction to at least one enrolled dealer;
reviewing the submitted data, wherein the enrolled dealer reviews the submitted data;
accepting the potential vehicle purchase transaction, wherein the at least one enrolled dealer accepts the potential vehicle purchase transaction;
transmitting the extracted captured data of the potential buyer, wherein the operator of the method transmit to the at least one dealer the extracted captured data; and
receiving a fee, wherein the at least one dealer submits a fee to the operator of the method.

2. The method operable to facilitate a purchase of a vehicle as recited in claim 1, and further including the step of establishing a catalog, wherein the catalog comprises at least one set of complete data regarding a potential vehicle purchase transaction.

3. The method operable to facilitate a purchase of a vehicle as recited in claim 2, and further including the step of inquiring about a trade-in vehicle, wherein the potential buyer can include a trade-in vehicle in the potential vehicle purchase transaction.

4. The method operable to facilitate a purchase of a vehicle as recited in claim 3, and further including the step of entering data pertaining to the trade-in vehicle.

5. The method operable to facilitate a purchase of a vehicle as recited in claim 4, wherein the fee paid to the operator from the enrolled dealer is a transactional fee based on a submitted potential vehicle purchase transaction.

6. The method operable to facilitate a purchase of a vehicle as recited in claim 4, wherein the fee paid to the operator is monthly enrollment fee.

7. The method operable to facilitate a purchase of a vehicle as recited in claim 4, wherein the data pertaining to the potential buyer includes credit information.

8. A method operable to provide a plurality of enrolled vehicle dealers with a qualified lead for a potential vehicle purchase wherein the method comprises the steps of:
providing a database, wherein the database further includes a software with the software providing a graphical interface for a user to engage in the method;
enrolling a plurality of vehicle dealers, wherein an operator of the method will enroll a plurality of vehicle dealers for participation in the method;
establishing a fee structure, wherein the operator of the method will establish a fee structure between the operator and the plurality of enrolled vehicle dealers
accessing the software, wherein a potential buyer accesses the software via a suitable computing device;
capturing personal data pertaining to the potential buyer;
providing data regarding to a multitude of vehicles available for sale from the enrolled plurality of dealers;
selecting at least one vehicle type and model, wherein the potential buyer chooses a vehicle type and model from the data of the multitude of vehicles provided;
listing available incentives, wherein the potential buyer is provided with a list of available financial incentives from the plurality of enrolled vehicle dealers;
inquiring about a trade-in vehicle, wherein the software of the present invention prompts the potential buyer for information about a trade-in vehicle;
assessing a value of the trade-in vehicle;
establishing a catalog of potential vehicle transactions, wherein the software records and saves all parameters regarding a potential vehicle transaction for the potential buyer;
extracting the captured personal data of the potential buyer;
submitting at least one potential vehicle transaction to a plurality of enrolled dealers;
reviewing the at least one potential vehicle transaction, wherein the plurality of enrolled dealers review the submitted potential vehicle transaction;
accepting the at least one potential vehicle transaction; and
transmitting the captured personal data of the potential buyer to one of the plurality of enrolled dealers.

9. The method operable to provide a plurality of enrolled vehicle dealers with a qualified lead for a potential vehicle purchase as recited in claim 8, and further including the step of collecting credit information from the potential buyer.

10. The method operable to provide a plurality of enrolled vehicle dealers with a qualified lead for a potential vehicle purchase as recited in claim 9, and further including the step of entering the desired amount of discount, wherein the potential buyer enters a desired discount amount to be applied to the potential vehicle transaction.

11. The method operable to provide a plurality of enrolled vehicle dealers with a qualified lead for a potential vehicle purchase as recited in claim 10, and further including the step of entering data pertaining to the trade-in vehicle.

12. The method operable to provide a plurality of enrolled vehicle dealers with a qualified lead for a potential vehicle purchase as recited in claim 11, wherein the fee structure paid to the operator from the enrolled plurality of dealers is monthly enrollment fee.

13. The method operable to provide a plurality of enrolled vehicle dealers with a qualified lead for a potential vehicle purchase as recited in claim 11, wherein the fee structure paid to the operator from the enrolled plurality of dealers is one time transactional fee.

14. The method operable to provide a plurality of enrolled vehicle dealers with a qualified lead for a potential vehicle purchase as recited in claim 11, and further including the step of providing a value for the trade-in vehicle.

15. A method operable to provide a plurality of enrolled vehicle dealers with qualified leads for a potential vehicle purchase wherein the method comprises the steps of:
providing a database, wherein the database further includes a software with the software providing a graphical interface for a user to engage in the method;
enrolling a plurality of vehicle dealers, wherein an operator of the method will enroll a plurality of vehicle dealers for participation in the method;
establishing a fee structure, wherein the operator of the method will establish a fee structure between the operator and the plurality of enrolled vehicle dealers
accessing the software, wherein a potential buyer accesses the software via a suitable computing device;
capturing personal data pertaining to the potential buyer;
providing data regarding to a multitude of vehicles available for sale from the enrolled plurality of dealers;
selecting at least one vehicle type and model, wherein the potential buyer chooses a vehicle type and model from the data of the multitude of vehicles provided;
listing available incentives, wherein the potential buyer is provided with a list of available financial incentives from the plurality of enrolled vehicle dealers;
entering the desired amount of discount, wherein the potential buyer enters a desired discount amount to be applied to the potential vehicle transaction;
inquiring about a trade-in vehicle, wherein the software of the present invention prompts the potential buyer for information about a trade-in vehicle;
assessing a value of the trade-in vehicle;
providing the value of the trade-in vehicle;
offering a plurality of vehicle accessory packages, wherein the potential buyer is provided with a plurality of vehicle accessory packages;
selecting at least one of the plurality of vehicle accessory packages;
establishing a catalog of potential vehicle transactions, wherein the software records and saves all parameters regarding a potential vehicle transaction for the potential buyer;
extracting the captured personal data of the potential buyer;
submitting at least one potential vehicle transaction to a plurality of enrolled dealers;
reviewing the at least one potential vehicle transaction, wherein the plurality of enrolled dealers review the submitted potential vehicle transaction;
accepting the at least one potential vehicle transaction; and
transmitting the captured personal data of the potential buyer to one of the plurality of enrolled dealers.

16. The method operable to provide a plurality of enrolled vehicle dealers with a qualified lead for a potential vehicle purchase as recited in claim 15, wherein the fee structure paid to the operator from the enrolled plurality of dealers is one time transactional fee.

17. The method operable to provide a plurality of enrolled vehicle dealers with a qualified lead for a potential vehicle purchase as recited in claim 15, wherein the fee structure paid to the operator from the enrolled plurality of dealers is monthly enrollment fee.
